(19) United States
(12) Patent Application Publication
(10) Pub. No.: US 2004/0248752 A1
(43) Pub. Date: Dec. 9, 2004

(54) Cleaning solution used in process of fabricating semiconductor device

(75) Inventors: Myoung-Ho Jung, Yongin-si (KR); Sang-Gyun Woo, Yongin-si (KR); Sung-Ho Lee, Gyeonggi-do (KR)

Correspondence Address: F. CHAU & ASSOCIATES, LLC, 130 WOODBURY ROAD, WOODBURY, NY, 11797, US

(73) Assignee: Samsung Electronics Co., Inc.

(21) Appl. No.: 10/748,903

(22) Filed: Dec. 30, 2003

(30) Foreign Application Priority Data
Mar. 13, 2003 (KR) 2003-15758

(51) Int. Cl. C11D 1/00

(52) U.S. Cl. 510/175

(57) ABSTRACT

A cleaning solution used in processes of fabricating semiconductor devices is disclosed. The cleaning solution includes deionized water and a surfactant represented by the following formula:

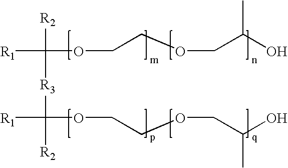

wherein R₁ and R₃ are carbides or fluorocarbons having 1 to 20 carbons, R₂ is hydrogen or carbide, m+p is an integer from 1 to 30, n+q is an integer from 0 to 10, and the surfactant is about 0.01 to about 1.0 wt. % based on the total weight of the deionized water.

### FIELD OF THE INVENTION

The present invention relates generally to a cleaning solution used in processes of fabricating semiconductor devices, and more particularly to a cleaning solution for preventing photoresist patterns from collapsing during a cleaning process.

### BACKGROUND OF THE INVENTION

As semiconductor devices become more highly integrated, a width of a photoresist pattern becomes very narrow and an aspect ratio of the photoresist pattern increases. Generally, a photoresist pattern is formed by an exposure-to-light process and a development process in a photolithography process followed by a cleaning process. In a cleaning process, development residues and a development solution between the photoresist patterns are removed by using deionized water. To dry the deionized water between the photoresist patterns formed on a wafer, the wafer is spun. However, during the drying process, the photoresist patterns may collapse. The photoresist patterns collapse because of the high surface tension, about 72 mN/m, of the deionized water used as a cleaning solution.

Typically, an anionic surfactant containing carbon or a cationic surfactant containing fluorine is mixed with deionized water [U.S. Pat. No. 6,451,510] to decrease the surface tension of deionized water. However, the surfactant is limited because it does not decrease the surface tension of a cleaning solution during a dynamic state of a cleaning process, e.g., spinning or agitation. Thus, even though a cleaning solution containing a conventional surfactant is used to clean photoresist patterns on a semiconductor substrate, the photoresist patterns on a semiconductor substrate still collapse.

Therefore, there is a need for a cleaning solution including a surfactant that decreases the surface tension of the cleaning solution in a dynamic state of a cleaning process.

### SUMMARY OF THE INVENTION

Exemplary embodiments of the invention include cleaning solutions that prevent the collapse of photoresist patterns on a semiconductor substrate during a dynamic state of a cleaning process.

Exemplary Embodiments of the invention include cleaning solutions comprising deionized water and a surfactant represented by formula 1 as follows:

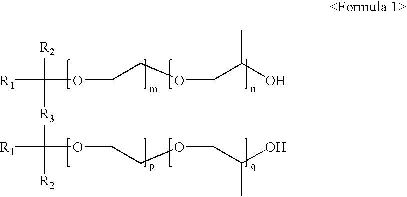

In formula 1, R₁ and R₃ are carbides or fluorocarbons having 1 to 20 carbons, and R₂ is hydrogen or carbide. m+p is an integer ranging from 1 to 30 and n+q is an integer ranging of 0 to 10.

In an exemplary embodiment, the surfactant is about 0.01 to about 1.0 wt. % based on the total weight of the deionized water.

In another exemplary embodiment, in formula 1, R₁ is selected from the group consisting of a methyl group,

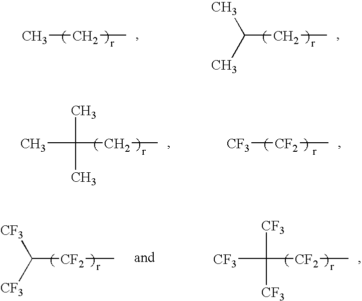

wherein r is an integer ranging from 1 to 15.

In yet another exemplary embodiment, in formula 1, R₂ is selected from the group consisting of hydrogen, a methyl group, an ethyl group, a propyl group, an isopropyl group, CF₃, CF₃CF₂ and

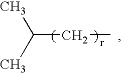

wherein r is an integer ranging from 1 to 15.

In still another exemplary embodiment, in formula 1, R₃ is selected from the group consisting of

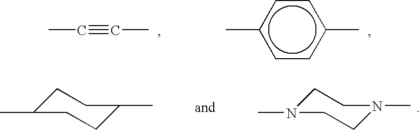

In other exemplary embodiments of the invention, the cleaning solution may include an anionic surfactant or a nonionic surfactant including fluorine. The nonionic surfactant including fluorine is preferably R_{f}CH₂CH₂O(CH₂CH₂O)_{X}H, wherein X is an integer ranging from 0 to 20 and R_{f} is F(CF₂CF₂)_{Y}, and wherein Y is an integer ranging from 1 to 10. The anionic surfactant including fluorine is preferably ammonium perfluoroalkylethoxy phosphorate. Preferably, the anionic surfactant or the nonionic surfactant including fluorine may be included at about 0.01 to about 1.0 wt. % based upon the total weight of the deionized water.

According to another exemplary embodiment of the present invention, a method for cleaning photoresist patterns is provided. The method for cleaning photoresist patterns on a semiconductor substrate comprises providing a semiconductor substrate including photoresist patterns, depositing a quantity of deionized water onto the semiconductor substrate such that the photoresist patterns are substantially or completely covered with deionized water, spinning the semiconductor substrate at about 500 rpm or less, depositing a cleaning solution on the semiconductor substrate, wherein the cleaning solution comprises deionized water and a surfactant represented by the following formula:

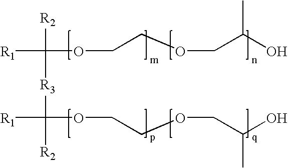

wherein R₁ and R₃ are carbides or fluorocarbons having 1 to 20 carbons, R₂ is hydrogen or carbide, m+p is an integer ranging from 1 to 30, n+q is an integer ranging from 0 to 10, and the surfactant is about 0.01 to about 1.0 wt. % based on a total weight of the deionized water and spinning the semiconductor substrate to remove the cleaning solution.

Thus, a cleaning solution and a method for using the same to prevent photoresist patterns from collapsing during a dynamic state of a cleaning process are disclosed.

### BRIEF DESCRIPTION OF THE DRAWINGS

FIG. 1 is a photograph of photoresist patterns on a semiconductor substrate after performing a cleaning process using a conventional cleaning solution.

FIG. 2 is a photograph of photoresist patterns on a semiconductor substrate after performing a cleaning process using a cleaning solution according to an exemplary embodiment of the present invention.

### DESCRIPTION OF EXEMPLARY EMBODIMENTS

The present invention will now be described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art.

Exemplary embodiments of the invention are directed to cleaning solutions comprising deionized water and a surfactant represented by formula 1 as follows:

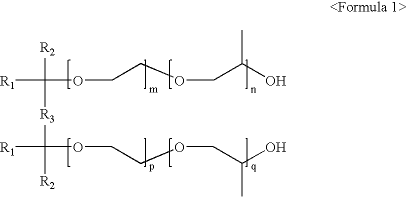

The surfactant is about 0.01 to about 1.0 wt. % based on the total weight of the deionized water.

In formula 1, R₁ and R₃ are carbides or fluorocarbons having 1 to 20 carbons, and R₂ is hydrogen or carbide. m+p is an integer ranging from 1 to 30 and n+q is an integer ranging of 0 to 10.

In formula 1, R₁ is preferably selected from the group consisting of a methyl group,

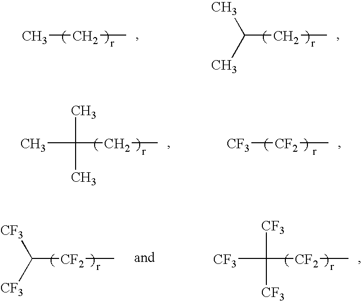

wherein r is an integer ranging from 1 to 15.

In formula 1, R₂ is preferably selected from the group consisting of hydrogen, a methyl group, an ethyl group, a propyl group, an isopropyl group, CF₃, CF₃CF₂ and

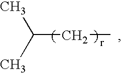

wherein r is an integer ranging from 1 to 15.

In formula 1, R₃ is preferably selected from the group consisting

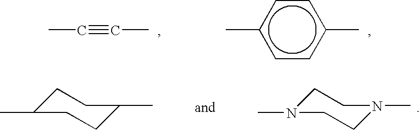

The cleaning solution may further include an anionic surfactant or a nonionic surfactant including fluorine. The nonionic surfactant including fluorine is preferably R_{f}CH₂CH₂O(CH₂CH₂O)_{X}H, wherein X is an integer ranging from 0 to 20 and R_{f} is F(CF₂CF₂)_{Y}, and wherein Y is an integer ranging from 1 to 10. The anionic surfactant including fluorine is preferably ammonium perfluoroalkylethoxy phosphorate. Preferably, the anionic surfactant or the nonionic surfactant including fluorine may be included at about 0.01 to about 1.0 wt. % based upon the total weight of the deionized water.

With an H-beam shape structure, a surfactant represented by formula 1 can effectively reduce the surface tension of a cleaning solution to less than about 30 mN/m in a dynamic state, e.g., spinning and agitation, of a cleaning process. Thus, even if a very small quantity of a surfactant, e.g., 0.01 wt. % based upon the total weight of deionized water, represented by formula 1 is included in a cleaning solution, it is possible to reduce the surface tension of the deionized water and prevent the formation of foam during a dynamic state of a cleaning process.

In addition, in a surfactant represented by formula 1, ethylene oxide, propylene oxide and a hydroxyl group indicate hydrophilicity, and R₁ and R₂ indicate hydrophobicity.

Further, if R₁ is a carbide such as

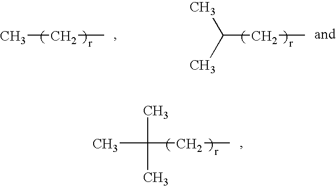

a surfactant of formula 1 can be readily synthesized and can significantly reduce the surface tension of a cleaning solution, thereby preventing photoresist patterns from collapsing during a dynamic state of a cleaning process.

Furthermore, if R₁ is a fluorine compound such as

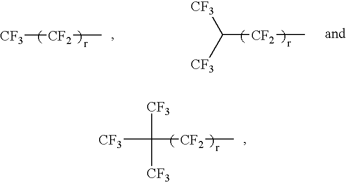

a surfactant of formula 1 can significantly reduce the surface tension of a cleaning solution, thereby preventing photoresist patterns from collapsing during a dynamic state of a cleaning process.

### Synthesis of a Cleaning Solution, According to an Exemplary Embodiment of the Present Invention

1.0 g of ethoxylated 2,5,8,11-tetramethyl-6-dodecyne-5,8-diol, represented by formula 2, as shown below, and 0.5 g of ammonium perfluoroalkyl phosphorate were dissolved in 1000 ml of deionized water. The solution was then filtered through a 0.02 μm filter to obtain a cleaning solution. Further, the ammonium perfluoroalkylethoxy phosphorate is an anionic surfactant containing fluorine that increases the solubility of the cleaning solution.

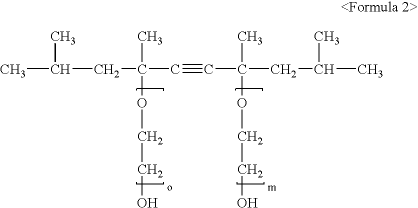

In addition, formula 2, as shown above, may be deduced from formula 1 wherein R₁ is a methyl group, R₂ is

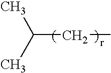

where r is 1,

R₃ is —C≡C—, and n and q are 0.

### EXAMPLE 1

### A Cleaning Process Using Only Deionized Water According to a Conventional Technology

A bottom anti-refractive layer was spin-coated on a silicon substrate to a thickness of about 600 Å. Next, the bottom anti-refractive layer was heated at a temperature of about 210° C. for about 90 seconds. Further, a copolymer of hydroxyethyl methacrylate/methylanthracene methacrylate (HEMA/ANTMA) was used as the bottom anti-refractive layer. A photoresist for an ArF eximer laser was then coated on the bottom anti-refractive layer and pre-baked at a temperature of about 120° C. for about 90 seconds. In addition, the photoresist is preferably coated on the bottom anti-refractive layer to a thickness of about 3600 Å. Further, a polymer synthesized by using adamantyl methacrylate, maleic anhydride and norbonene was used as the photoresist for the ArF excimer laser. Next, the photoresist was exposed to light by using a scanner having an ArF excimer laser. Further, a photomask that can produce 100 nm L/S pattern was used. Then, a post-exposure bake (PEB) process was performed with respect to the photoresist at a temperature of about 120° C. for about 90 seconds. Next, the photoresist was developed by using a tetramethylammonium hydroxide (TMAH) of 2.38 wt % for about 60 seconds to form a photoresist pattern.

A cleaning process was then performed with respect to the silicon substrate having the photoresist pattern by using deionized water in an excessive quantity to remove development residues. Then, the silicon substrate having the photoresist pattern was spun to remove the deionized water from the pattern photoresist.

FIG. 1 is a photograph of a semiconductor substrate having a photoresist pattern after performing a cleaning process using a conventional cleaning solution. Referring to FIG. 1, it can be seen in FIG. 1 that photoresist patterns cleaned by using a conventional cleaning solution have collapsed.

### EXAMPLE 2

### A Cleaning Process Using a Cleaning Solution According to an Exemplary Embodiment of the Present Invention

Photoresist patterns were formed through the same coating, exposure, and development processes as discussed above with respect to example 1.

Then, deionized water of an excessive quantity was deposited on the silicon substrate having the photoresist patterns through a nozzle. In other words, deionized water can be deposited on the photoresist patterns such that the photoresist patterns are substantially or completely covered with deionized water. Further, development solution and residues were removed by spinning the semiconductor substrate. Preferably, the semiconductor substrate is spun at about 500 rpm or less. In addition, the photoresist patterns may be fully submerged in the deionized water. After performing the spinning process, a cleaning solution synthesized in accordance with the exemplary embodiments of the present invention discussed above was deposited, e.g., by spraying or puddling technique, on the photoresist patterns. After the deposition of the cleaning solution, the cleaning solution was allowed to stand on the photoresist patterns for about 10 seconds. The silicon substrate having the photoresist patterns was then spun to remove the cleaning solution.

FIG. 2 is a photograph of photoresist patterns on a semiconductor substrate after performing a cleaning process using a cleaning solution in accordance with the embodiments of the present invention. Referring to FIG. 2, it can be seen in FIG. 2 that the photoresist patterns are prevented from collapsing during a cleaning process by using a cleaning solution in accordance with the embodiments of the present invention.

Accordingly, a cleaning solution according to embodiments of the present invention may include a non-ionic surfactant of Gemini-type represented by formula 1 above, so that the surface tension of the cleaning solution can be reduced in a dynamic state of a cleaning process, thereby preventing photoresist patterns from collapsing.

What is claimed is:

1. A cleaning solution comprising:
deionized water; and
a surfactant represented by the following formula: 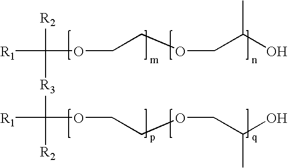
wherein R₁ and R₃ are carbides or fluorocarbons having 1 to 20 carbons, R₂ is hydrogen or carbide, m+p is an integer ranging from 1 to 30, n+q is an integer ranging from 0 to 10.

2. The cleaning solution as claimed in claim 1, wherein R₁ is selected from the group consisting of a methyl group, 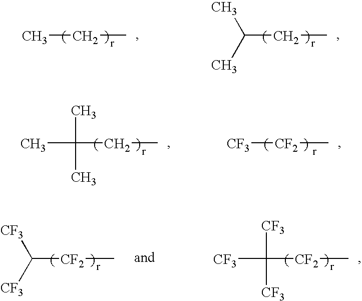
wherein r is an integer ranging from 1 to 15.

3. The cleaning solution as claimed in claim 1, wherein R₂ is selected from the group consisting of hydrogen, a methyl group, an ethyl group, a propyl group, an isopropyl group, CF₃, CF₃CF₂ and 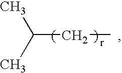
wherein r is an integer ranging from 1 to 15.

4. The cleaning solution as claimed in claim 1, wherein R₃ is selected from the group consisting of

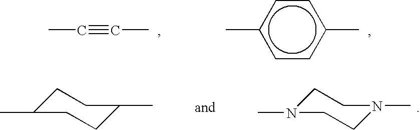

5. The cleaning solution as claimed in claim 1, further comprising an anionic surfactant containing fluorine or a nonionic surfactant containing fluorine.

6. The cleaning solution as claimed in claim 5, wherein the nonionic surfactant containing fluorine is R_{f}CH₂CH₂O(CH₂CH₂O)_{X}H, wherein X is an integer ranging from 0 to 20 and R_{f} is F(CF₂CF₂)_{Y}, and wherein Y is an integer ranging from 1 to 10.

7. The cleaning solution as claimed in claim 5, wherein the anionic surfactant containing fluorine is ammonium perfluoroalkylethoxy phosphorate.

8. The cleaning solution as claimed in claim 5, wherein the anionic surfactant containing fluorine or the nonionic surfactant containing fluorine is about 0.01 to about 1.0 wt. % based on a total weight of the deionized water.

9. The cleaning solution as claimed in claim 1, wherein the surfactant is about 0.01 to about 1.0 wt. % based on a total weight of the deionized water.

10. A method for cleaning photoresist patterns on a semiconductor substrate, comprising the steps of:
providing a semiconductor substrate having photoresist patterns;
depositing deionized water on the photoresist patterns such that the photoresist patterns are substantially or completely covered with the deionized water;
spinning the semiconductor substrate at about 500 rpm or less;
depositing a cleaning solution on the photoresist patterns, wherein the cleaning solution comprises deionized water and a surfactant represented by the following formula: 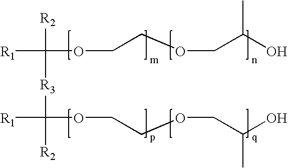
wherein R₁ and R₃ are carbides or fluorocarbons having 1 to 20 carbons, R₂ is hydrogen or carbide, m+p is an integer ranging from 1 to 30, n+q is an integer ranging from 0 to 10; and
spinning the semiconductor substrate to remove the cleaning solution.

11. The method of claim 10, wherein R₁ is selected from the group consisting of a methyl group, 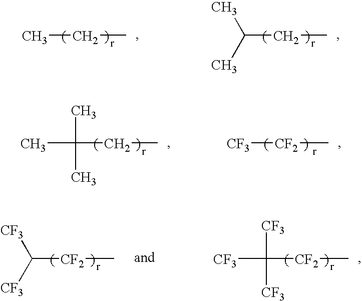
wherein r is an integer ranging from 1 to 15.

12. The method of claim 10, wherein the surfactant is about 0.01 to about 1.0 wt. % based on a total weight of the deionized water

13. The method of claim 10, wherein R₂ is selected from the group consisting of hydrogen, a methyl group, an ethyl group, a propyl group, an isopropyl group, CF₃, CF₃CF₂ and 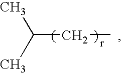
wherein r is an integer ranging from 1 to 15.

14. The method of claim 10, wherein R₃ is selected from the group consisting of

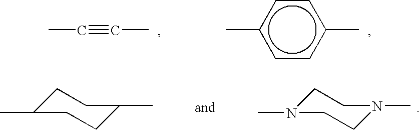

15. The method of claim 10, wherein the cleaning solution further comprises an anionic surfactant containing fluorine or a nonionic surfactant containing fluorine.

16. The method of claim 14, wherein the nonionic surfactant containing fluorine is R_{f}CH₂CH₂O(CH₂CH₂O)_{X}H, wherein X is an integer ranging from 0 to 20 and R_{f} is F(CF₂CF₂)_{Y}, and wherein Y is an integer ranging from 1 to 10.

17. The method of claim 14, wherein the anionic surfactant containing fluorine is ammonium perfluoroalkylethoxy phosphorate.

18. The method of claim 14, wherein the anionic surfactant containing fluorine or the nonionic surfactant containing fluorine is about 0.01 to about 1.0 wt. % based on a total weight of the deionized water.

19. A cleaning solution used for preventing the collapse of photoresist patterns formed on a semiconductor substrate during a dynamic state of a cleaning process which comprises deionized water and a surfactant at about 0.01 to about 1.0 wt. % based on a total weight of the deionized water, wherein the surfactant is represented by the following formula: 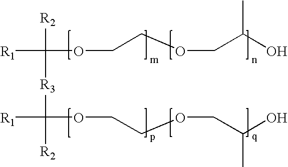
wherein R₁ and R₃ are carbides or fluorocarbons having 1 to 20 carbons, R₂ is hydrogen or carbide, m+p is an integer ranging from 1 to 30, n+q is an integer ranging from 0 to 10.

20. The cleaning solution as claimed in claim 19, wherein R₁ is selected from the group consisting of a methyl group, 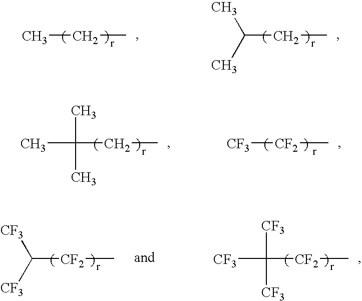
wherein r is an integer ranging from 1 to 15.

21. The cleaning solution as claimed in claim 19, wherein R₂ is selected from the group consisting of hydrogen, a methyl group, an ethyl group, a propyl group, an isopropyl group, CF₃, CF₃CF₂ and 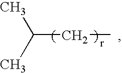
wherein r is an integer ranging from 1 to 15.

22. The cleaning solution as claimed in claim 19, wherein R₃ is selected from the group consisting of

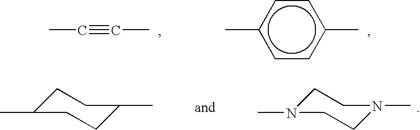

23. The cleaning solution as claimed in claim 19, further comprising an anionic surfactant containing fluorine or a nonionic surfactant containing fluorine.

24. The cleaning solution as claimed in claim 23, wherein the nonionic surfactant containing fluorine is R_{f}CH₂CH₂O(CH₂CH₂O)_{X}H, wherein X is an integer ranging from 0 to 20 and R_{f} is F(CF₂CF₂)_{Y}, and wherein Y is an integer ranging from 1 to 10.

25. The cleaning solution as claimed in claim 23, wherein the anionic surfactant containing fluorine is ammonium perfluoroalkylethoxy phosphorate.

26. The cleaning solution as claimed in claim 23, wherein the anionic surfactant containing fluorine or the nonionic surfactant containing fluorine is about 0.01 to about 1.0 wt. % based on a total weight of the deionized water.
